(19) United States
(12) Patent Application Publication
(10) Pub. No.: US 2019/0014199 A1
(43) Pub. Date: Jan. 10, 2019

(54) ELECTRONIC EQUIPMENT AND METHOD FOR CONTROLLING THE SAME

(71) Applicant: CANON KABUSHIKI KAISHA, Tokyo (JP)

(72) Inventors: Kiyoshi Nitto, Saitama-shi (JP); Yosuke Fukai, Kawasaki-shi (JP); Toshihiro Ogawa, Tokyo (JP); Junichiro Iwamatsu, Tokyo (JP)

(21) Appl. No.: 16/029,325

(22) Filed: Jul. 6, 2018

(30) Foreign Application Priority Data
Jul. 10, 2017 (JP) 2017-134759
Sep. 29, 2017 (JP) 2017-191749

(51) Int. Cl. H04M 1/02; H04B 17/10

(52) U.S. Cl. CPC H04M 1/0254; H04M 1/0264; H04B 17/10

(57) ABSTRACT

A unit configured to acquire information on frequencies used by an electronic equipment body and all devices attached to the electronic equipment body is provided. By such a unit, the information on the frequencies used by the electronic equipment body and the devices attached to the electronic equipment body is acquired. A determination unit configured to determine, based on the frequency information, whether or not desired operation is to be performed and a notification unit configured to notify a determination result are provided.

### BACKGROUND

### Field of the Disclosure

The present disclosure relates to electronic equipment from which an image pickup module is detachable and the method for controlling the electronic equipment. Specifically, the present disclosure relates to electronic equipment suitable for optimization of, e.g., operation among multiple image pickup modules and the method for controlling the electronic equipment.

### Description of the Related Art

Electronic equipment called a “smart device” has been well-known, the smart device being configured to implement various desired functions by a combination of modules grouped as blocks in functional units. Such a smart device includes a body provided with multiple slots, and multiple modules with different functions. A wide variety of modules are attached/detached to/from the slots of the body in any combination. For example, when a module with an image pickup function is attached to the slots of the body, the image pickup function can be utilized by operation of an application program installed on an OS.

There are a wide variety of image pickup modules corresponding to such a smart device. As long as an attachment/detachment unit or a communication unit for the body satisfy certain standards, an optical lens focal length or an image pickup sensor size may be different, for example. Further, a manufacturer designing these image pickup modules are not necessarily limited to a particular company, and multiple companies such as a camera manufacturer and an electronic manufacturer may be present. Moreover, the image pickup module has less restriction such as component arrangement, and has a high degree of freedom in design. Thus, the image pickup module can be designed with the most suitable layout convenient for specifications or a manufacturer.

Further, as described above, the modules can be relatively freely combined, and therefore, multiple image pickup modules can be attached to different slots, for example. In this case, when a corresponding application program is installed, a well-known image composition function and a well-known image measurement function as so-called compound-eye camera functions can be utilized.

Japanese Patent Laid-Open No. 2002-268111 discloses, as an image pickup module forming a camera, a module having the function of detecting vibration by means of a vibration detection sensor. For optical electronic equipment such as a camera, the configuration for reducing so-called “camera shake” is disclosed. For example, a configuration employing the following method is described: part of an image capturing optical system is driven based on an angle signal obtained by amplification of the output (an angular velocity signal) of a vibrating gyroscope as a vibration detection sensor and conversion of the resultant in an integration circuit, and in this manner, vibration on an image capturing medium such as a CMOS is reduced. Among vibrating gyroscopes, there is a gyroscope using a crystal vibrator. The crystal vibrator type vibrating gyroscope is configured to sense, as an angular velocity, Coriolis force generated by external vibration in a state in which a tuning fork type vibrator is vibrating with a predetermined drive frequency (several tens of kHz). A drive source such as optical focusing motor is provided, and a drive frequency generated by driving of such a motor might be coincident with the drive frequency of the vibrating gyroscope. In a case where such a drive frequency is coincident with or extremely close to the drive frequency of the vibrating gyroscope, a great angular velocity signal is output, and exceeds a detection circuit dynamic range. In this case, there is a probability that vibration not targeted for detection is synthesized with a “camera shake” correction target signal and erroneous correction driving is performed. For this reason, in Japanese Patent Laid-Open No. 2002-268111, e.g., a motor of the optical electronic equipment is driven with a frequency other than the frequency of the gyroscope.

However, in Japanese Patent Laid-Open No. 2002-268111, as long as information on the frequencies of a piezoelectric device, the vibrating gyroscope, etc. mounted on the image pickup module is, for example, not registered in advance in a memory built in a body side, failure might be caused depending on combination. Moreover, Japanese Patent Laid-Open No. 2002-268111 fails to disclose control in the case of changing to a module using a piezoelectric device or a vibrating gyroscope with a different drive frequency.

Accordingly, there is a need to provide a unit configured to prevent malfunction due to a combination of a wide variety of image pickup modules in electronic equipment configured to implement functions by means of the multiple image pickup modules.

### SUMMARY

The present disclosure includes multiple modules including at least one detachable module, an acquisition unit configured to acquire information regarding a frequency used by each module, the information being stored for the each module, and a control unit configured to limit or stop operation of at least one module in a case where the frequencies used by the multiple modules interfere with each other based on the frequency information acquired by the acquisition unit.

Further features of the present disclosure will become apparent from the following description of exemplary embodiments (with reference to the attached drawings).

### BRIEF DESCRIPTION OF THE DRAWINGS

FIGS. 1A and 1B are external views of a smart device according to one or more aspects of the present disclosure.

FIGS. 2A and 2B are external views of modules attached to the smart device according to one or more aspects of the present disclosure.

FIGS. 3A and 3B are views for describing the method for attaching the modules to a smart device body according to one or more aspects of the present disclosure.

FIGS. 4A and 4B are views for describing joint between an EPM provided at the smart device body according to one or more aspects of the present disclosure and a magnetic body provided at the module by magnetic force.

FIG. 5 includes FIGS. 5A and 5B which are block diagrams of a configuration example of the smart device according to one or more aspects of the present disclosure.

FIG. 6 is a flowchart of a main routine of an application program control module according to one or more aspects of the present disclosure.

FIG. 7 is a flowchart of release processing according to one or more aspects of the present disclosure.

FIG. 8 is a flowchart of attachment processing according to one or more aspects of the present disclosure.

FIG. 9 is a flowchart of image capturing application execution processing according to one or more aspects of the present disclosure.

FIG. 10 is a flowchart of used frequency verification according to one or more aspects of the present disclosure.

FIG. 11 is a block diagram of a configuration example of a camera system according to one or more aspects of the present disclosure.

FIGS. 12A and 12B are charts of a relationship of used frequencies of an actuator and a gyroscope sensor in a digital camera according to one or more aspects of the present disclosure.

FIGS. 13A and 13B are views of a configuration example of an annular vibration type motor according to one or more aspects of the present disclosure.

FIGS. 14A and 14B are graphs of an example of progressive vibration generated on a face of an elastic body according to one or more aspects of the present disclosure.

### DESCRIPTION OF THE EMBODIMENTS

### First Embodiment

Hereinafter, an example of a preferred embodiment of the present disclosure will be described in detail with reference to the attached drawings. Hereinafter, a case where a smart device is used as electronic equipment will be described by way of example. However, the present disclosure is not limited to the smart device, and is applicable to electronic equipment using multiple modules. Moreover, in the present embodiment, the multiple modules will be described as a replaceable configuration.

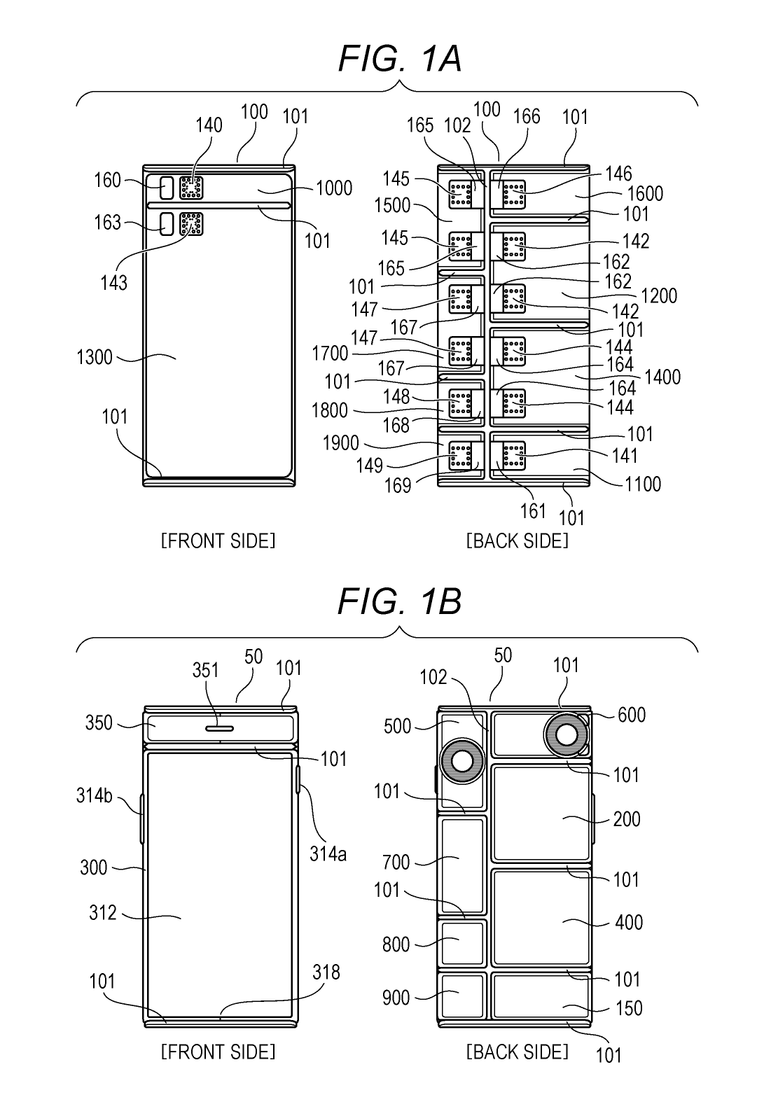

FIGS. 1A and 1B are external views of the smart device as the electronic equipment according to the embodiment of the present disclosure.

FIG. 1A illustrates an external view of a smart device body 100 from a front side and an external view of the smart device body 100 from a back side. As illustrated in FIG. 1A, multiple ribs 101 having both of a guide function upon module attachment and a holding function are formed on the front side of the smart device body 100. Moreover, on the back side of the smart device body 100, multiple ribs 101 are formed, and a spine 102 configured to divide the smart device body 100 into right and left regions is formed.

The ribs 101 and the spine 102 have both of a guide function upon module attachment and a holding function, and also have the function of enhancing rigidity of the smart device body 100. Hereinafter, the ribs 101 and the spine 102 will be collectively referred to as a “frame structure.”

On the front and back sides, the smart device body 100 is, by the ribs 101 and the spine 102, divided into multiple module attachment regions (1000, 1100, 1200, 1300, 1400, 1500, 1600, 1700, 1800, 1900). Hereinafter, these module attachment regions will be referred to as “slots.” The slots 1000, 1100, 1200, 1300, 1400, 1500, 1600, 1700, 1800, 1900 are each provided with electropermanent magnets (hereinafter referred to as “EPMs”) 160 to 169 serving as an electromagnetic attachment/detachment mechanism. Note that the EPM will be described in detail later. Body-side contactless communication units (hereinafter referred to as “body-side CMCs”) 140 to 149 for data transmission/reception between the smart device body 100 and each module are each provided near the EPMs 160 to 169. That is, at each of the slots 1000, 1100, 1200, 1300, 1400, 1500, 1600, 1700, 1800 and 1900, at least a pair of EPMs 160 to 169 and body-side CMCs 140 to 149 is provided. Note that as illustrated in FIG. 1A, multiple EPMs 160 to 169 and multiple body-side CMCs 140 to 149 may be provided according to a slot size.

In the smart device body 100, the EPMs 160 and 163 are arranged in the vicinity of a left end portion on the front side of FIG. 1A, and the body-side CMCs 140 and 143 are each arranged on the right side of the EPMs 160 and 163. On the back side of the smart device body 100, the EPMs 161, 162, 164 to 169 are arranged adjacent to the spine 102. In the left region of the spine 102 on the back side of FIG. 1A, the EPMs 165, 167 to 169 are provided. Further, the body-side CMCs 145, 147 to 149 are each arranged on the left side of the EPMs 165, 167 to 169. Moreover, in the right region of the spine 102, the EPMs 161, 162, 164 and 166 are provided. Further, the body-side CMCs 141, 142, 144 and 146 are each arranged on the right side of the EPMs 161, 162, 164 and 166.

FIG. 1B is an external view from the front side and an external view from the back side in a state in which the modules are attached to the smart device body 100. As illustrated in FIG. 1B, modules 150, 200, 300, 350, 400, 500, 600, 700, 800 and 900 having each function are attached to the front and back sides of the smart device body 100. The module (hereinafter referred to as a “display operation module”) 300 including a display unit 312 having a touch sensing function across a substantially entire face is attached to the lower slot 1300 on the front side of the smart device body 100.

A power supply button 314a configured to switch a power supply of the smart device between ON and OFF is formed on a right side face of the display operation module 300 on the front side of FIG. 1B. A volume adjustment button 314b configured to adjust a volume is formed on a left side face of the display operation module 300. Further, a microphone section 318 configured to detect caller's voice when the smart device functions as movable member wireless communication equipment is provided at the display operation module 300. The microphone section 318 also plays a role in collection of motion image sound when the smart device functions as a video camera. Moreover, the speaker module 350 is attached to the upper slot 1000 on the front side of the smart device body 100. A speaker section 351 configured to output received voice when the smart device functions as the movable member wireless communication equipment is provided at the speaker module 350, and in addition, the speaker section 351 is configured to output music or operation sound.

On the other hand, on the back side of the smart device body 100, the first image pickup module 500 having various image capturing functions is attached to the upper slot 1500 on the left side of the spine 102. Moreover, the second image pickup module 600 is attached to the upper slot 1600 on the right side of the spine 102. In the smart device body 100, at least the slot 1500 and the slot 1600 are on the substantially same plane, and the optical axes of the first image pickup module 500 and the second image pickup module 600 are substantially parallel to each other. This leads to a configuration in which framing of the same object in each image capturing range of the first image pickup module 500 and the second image pickup module 600. The first image pickup module 500 and the second image pickup module 600 are commonalized such that an attachment/detachment unit and a communication unit for the smart device body 100 satisfy certain standards, but are different from each other in component arrangement.

The wireless LAN module 700 configured to wirelessly transmit/receive data to/from the outside is attached to the slot 1700 formed below the upper slot 1500 on the left side of the spine 102. Further, the orientation sensing module 800 configured to sense orientation of the smart device is attached to the slot 1800 below the slot 1700. The orientation sensing module 800 utilizes angular velocity information acquired from a three-axis gyroscope sensor, thereby sensing the orientation of the smart device. The movable member communication module 900 having one or more of various long-distance communication functions such as TDMA, CDMA, and LTE is attached to the lower slot 1900 on the left side of the spine 102. The application program control module 200 configured to control the entirety of the smart device is attached to the slot 1200 formed below the upper slot 1600 on the right side of the spine 102.

As described above, in a case where a corresponding application program is installed, various desired functions can be utilized via the application program control module 200. For example, in the case of a dedicated call application, the movable member communication module 900 is operated via the application program control module 200 so that a call function can be utilized. Similarly, in the case of a dedicated Internet connection application, the wireless LAN module 700 is operated via the application program control module 200 so that a web browsing function via Internet connection can be utilized. For example, in the case of a dedicated image capturing application, the first image pickup module 500 and the second image pickup module 600 are operated via the application program control module 200 so that an image composition function and an image measurement function as compound-eye camera functions can be utilized.

The power supply module 400 configured to supply power to the smart device is attached to the slot 1400 below the slot 1200. Further, the recording module 150 configured to save various types of data such as captured image data is attached to the lower slot 1100 on the right side of the spine 102.

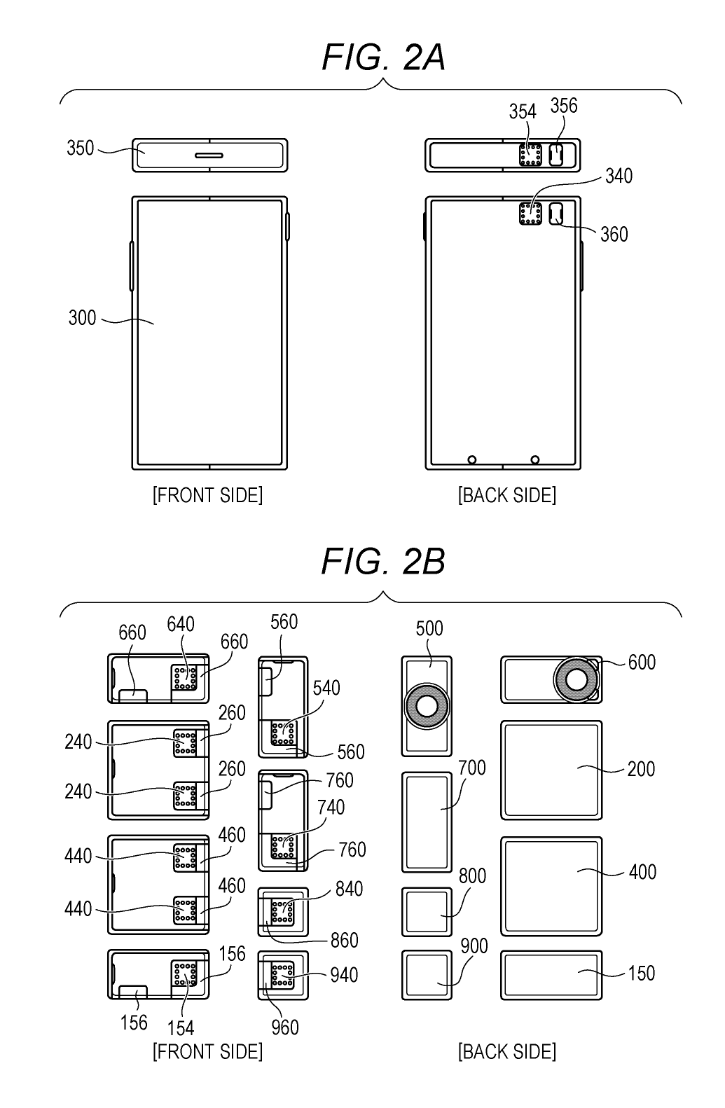

FIGS. 2A and 2B are external views of the modules 150, 200, 300, 350, 400, 500, 600, 700, 800 and 900 attached to the smart device body 100 as a first embodiment of the electronic equipment of the present disclosure. FIG. 2A is an external view of the display operation module 300 and the speaker module 350 to be attached to the front side of the smart device body 100 from the front side and an external view of the display operation module 300 and the speaker module 350 from the back side. FIG. 2B is an external view of each module to be attached to the back side of the smart device body 100 from the front side and an external view of each module from the back side (the first image pickup module 500, the second image pickup module 600, the wireless LAN module 700, the orientation sensing module 800, the movable member communication module 900, the application program control module 200, the power supply module 400, and the recording module 150).

As illustrated in FIG. 2A, magnetic bodies 360 and 356 are, on back faces of the display operation module 300 and the speaker module 350, provided at positions facing the EPMs 163 and 160 provided at the smart device body 100. A soft magnetic body with small coercive force and great magnetic permeability is preferred as the materials of the magnetic bodies 360 and 356 used herein. In the present embodiment, HIPERCO™ 50 as soft magnetic alloy of iron, cobalt, and vanadium is employed. Further, module-side contactless communication units (hereinafter referred to as “module-side CMCs”) 340 and 354 configured to transmit/receive data to/from the smart device body 100 are provided at positions facing the body-side CMCs 143 and 140 provided at the smart device body 100. Pairs of magnetic body 360 and 356 and module-side CMCs 340 and 354 are, one by one, provided adjacent to each other.

On the other hand, as illustrated in FIG. 2B, magnetic bodies 560 and 660 are, on back faces of the first image pickup module 500 and the second image pickup module 600, provided at positions facing the EPMs 165 and 166 provided at the smart device body 100. Magnetic bodies 760, 860 and 960 are, on back faces of the wireless LAN module 700, the orientation sensing module 800, and the movable member communication module 900, provided at positions facing the EPMs 167 to 169 provided at the smart device body 100. Further, magnetic bodies 260, 460, 156 are provided on back faces of the application program control module 200, the power supply module 400, and the recording module 150. The magnetic bodies 260, 460 and 156 are provided at positions facing the EPMs 162, 164 and 161 provided at the smart device body 100. A soft magnetic body is also preferred as the materials of the magnetic bodies 560, 660, 760, 860, 960, 260, 460 and 156 used herein.

Module-side CMCs 540, 640, 740, 840, 940, 240, 440 and 154 configured to transmit/receive data to/from the smart device body 100 are provided at positions facing the body-side CMCs 145 to 149, 142, 144 and 141. The magnetic bodies 560, 660, 760, 860, 960, 260, 460 and 156 are each provided adjacent to the module-side CMCs 540, 640, 740, 840, 940, 240, 440 and 154. Moreover, a pair of first image pickup modules 500, a pair of second image pickup modules 600, a pair of wireless LAN modules 700, a pair of orientation sensing modules 800, a pair of movable member communication modules 900, and a pair of recording modules 150 are provided. Further, two pairs of application program control modules 200 and two pairs of power supply modules 400 are provided.

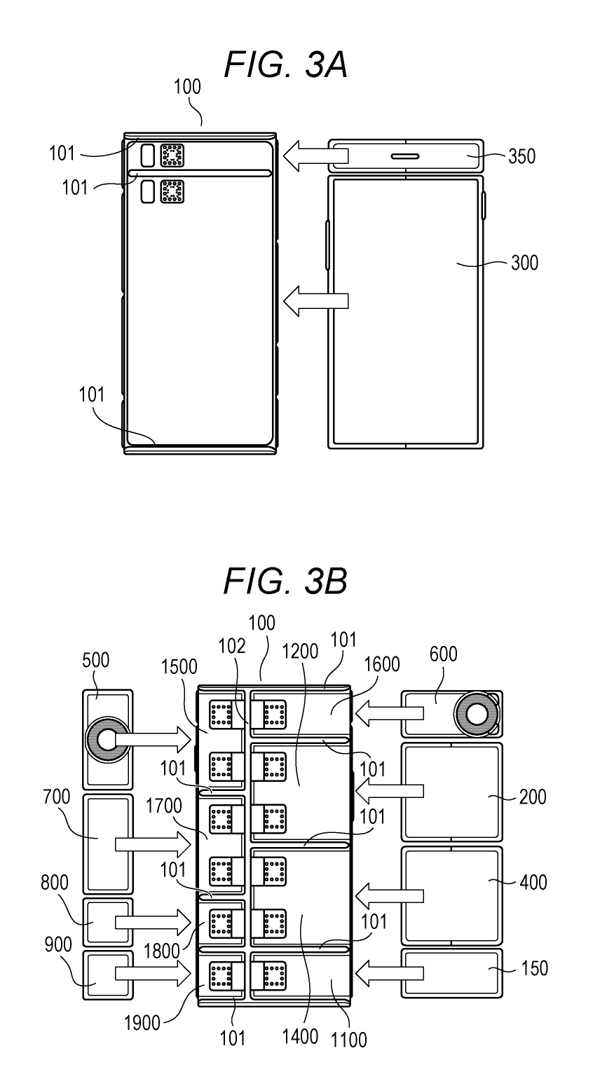

FIGS. 3A and 3B are views for describing the method for attaching the modules 150, 200, 300, 350, 400, 500, 600, 700, 800 and 900 to the smart device body 100 as the first embodiment of the electronic device of the present disclosure. FIG. 3A is a view for describing the method for attaching the display operation module 300 and the speaker module 350 to the front side of the smart device body 100. FIG. 3B is a view for describing the method for attaching each of the following modules to the back side of the smart device body 100 (the first image pickup module 500, the second image pickup module 600, the wireless LAN module 700, the orientation sensing module 800, the movable member communication module 900, the application program control module 200, the power supply module 400, and the recording module 150).

As illustrated in FIG. 3A, the display operation module 300 and the speaker module 350 are attached to the smart device body 100 in such a manner that the display operation module 300 and the speaker module 350 slide from a lateral direction along the ribs 101. At this point, the display operation module 300 and the speaker module 350 can be inserted from any of the right and left sides of the smart device body 100.

As illustrated in FIG. 3B, the first image pickup module 500, the wireless LAN module 700, the orientation sensing module 800, and the movable member communication module 900 are attached to the smart device body 100 in such a manner that the first image pickup module 500, the wireless LAN module 700, the orientation sensing module 800, and the movable member communication module 900 slide from the left side. Each module comes into contact with the spine 102 from the left side, and therefore, the positions of the modules 500, 700, 800 and 900 with respect to the smart device body 100 are determined. Moreover, the second image pickup module 600, the application program control module 200, the power supply module 400, and the recording module 150 are attached to the smart device body 100 in such a manner that the second image pickup module 600, the application program control module 200, the power supply module 400, and the recording module 150 slide from the right side. Each module comes into contact with the spine 102 from the right side, and therefore, the positions of the modules 600, 200, 400 and 100 with respect to the smart device body 100 are determined.

In the present embodiment, the slots provided on the back side of the smart device body 100 as illustrated in FIG. 3B are broadly divided into three types according to size. First, the slots 1500, 1600, 1700 and 1100 are of the same type. For example, any of these four slots may be selected for attachment of the first image pickup module 500. Moreover, the largest slots 1200 and 1400 are of the same type. For example, any of these two slots may be selected for attachment of the application program control module 200. Similarly, the smallest slots 1800 and 1900 are of the same type. For example, any of these two slots may be selected for attachment of the orientation sensing module 800.

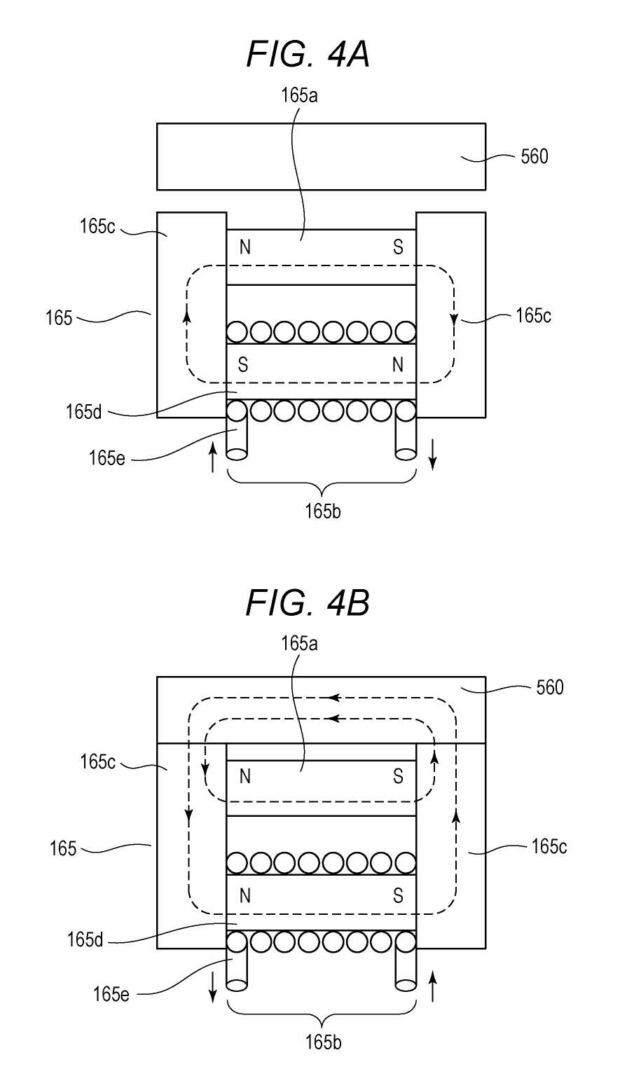

FIGS. 4A and 4B are views for describing joint between the EPM provided at the smart device body according to the first embodiment of the present disclosure and the magnetic body provided at the module by magnetic force. Joint between the EPM 165 provided at the smart device body 100 as the first embodiment of the electronic equipment of the present disclosure and the magnetic body 560 provided at the first image pickup module 500 by the magnetic force is schematically illustrated. FIG. 4A is a partial enlarged view in a state in which the smart device body 100 and the first image pickup module 500 are not joined together by the magnetic force. FIG. 4B is a partial enlarged view in a state in which the smart device body 100 and the first image pickup module 500 are joined together by the magnetic force. Note that FIGS. 4A and 4B illustrate a combination of the EPM 165 and the magnetic body 560 by way of example, but the same applies to other combinations of the EPM and the magnetic body.

As illustrated in FIG. 4A, the EPM 165 has such a structure that both side faces of a permanent magnet 165a with a fixed polarity and a permanent electromagnet 165b are coupled and held by magnetic bodies 165c. For example, a neodymium magnet with an extremely-high magnetic flux density is suitable as the permanent magnet 165a used herein. Moreover, the permanent electromagnet 165b includes a reversible permanent magnet 165d formed of a hard magnetic body such as alnico, and a coil 165e wound around the reversible permanent magnet 165d. When current is applied to the coil 165e, the reversible permanent magnet 165d is magnetized in one direction, and such a magnetization state is held even after energization has ended. An energization time for the coil 165e is a relatively-short time of about one to several seconds. In this manner, the permanent electromagnet 165b serves as a permanent electromagnet whose polarity is variable by a change in the direction of current applied to the coil 165e.

When the coil 165e is energized in the state illustrated in FIG. 4A, the reversible permanent magnet 165d is magnetized, and the permanent electromagnet 165b generates a magnetic line in an attracting direction with respect to the direction of a magnetic line of the permanent magnet 165a with the fixed polarity. As a result, the magnetic line of the permanent electromagnet 165b and the magnetic line of the permanent magnet 165a form a closed loop shape, and therefore, the magnetic force of attracting the magnetic body 560 of the module 500 becomes extremely weak. Thus, the module 500 is disengaged without receiving attraction force from the EPM 165.

On the other hand, when the coil 165e is energized in the opposite direction of FIG. 4A, the reversible permanent magnet 165d is magnetized, and the permanent electromagnet 165b generates a magnetic line in a repelling direction with respect to the direction of the magnetic line of the permanent magnet 165a with the fixed polarity, as illustrated in FIG. 4B. As a result, the magnetic line of the permanent electromagnet 165b and the magnetic line of the permanent magnet 165a are strengthened each other, and therefore, the magnetic force of attracting the magnetic body 560 provided at the module 500 is extremely increased. Thus, the module 500 receives the attraction force from the EPM 165, and is fixed to the smart device body 100. As described above, in the present embodiment, the EPM is employed as an attachment/detachment unit, and therefore, both of workability and reliability in attachment/detachment of each module are realized.

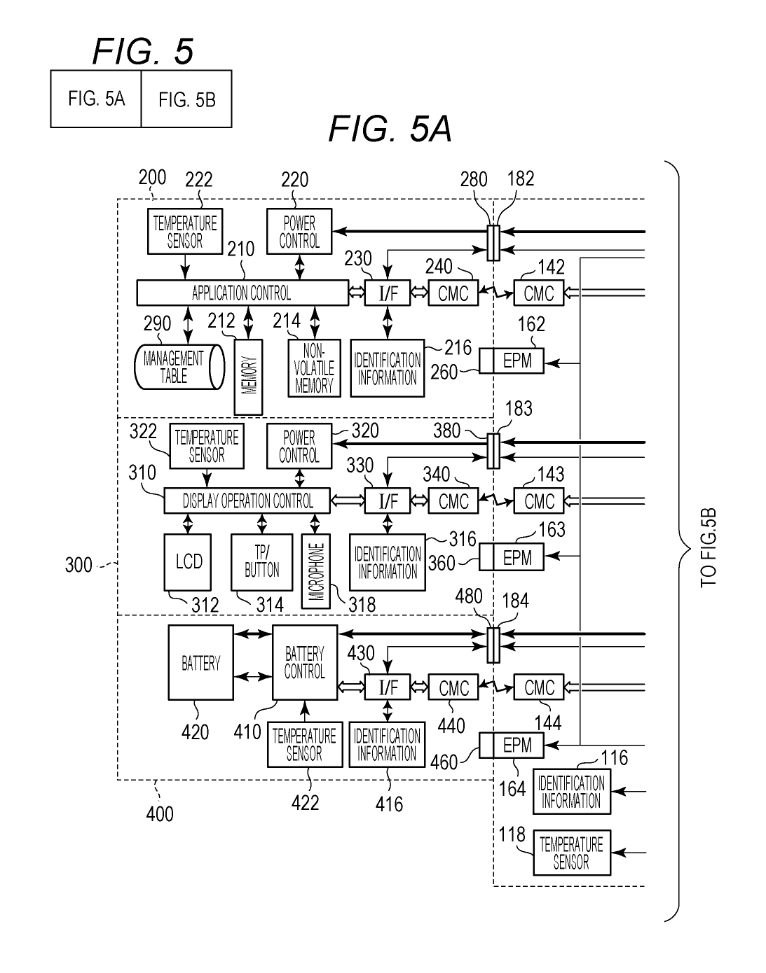

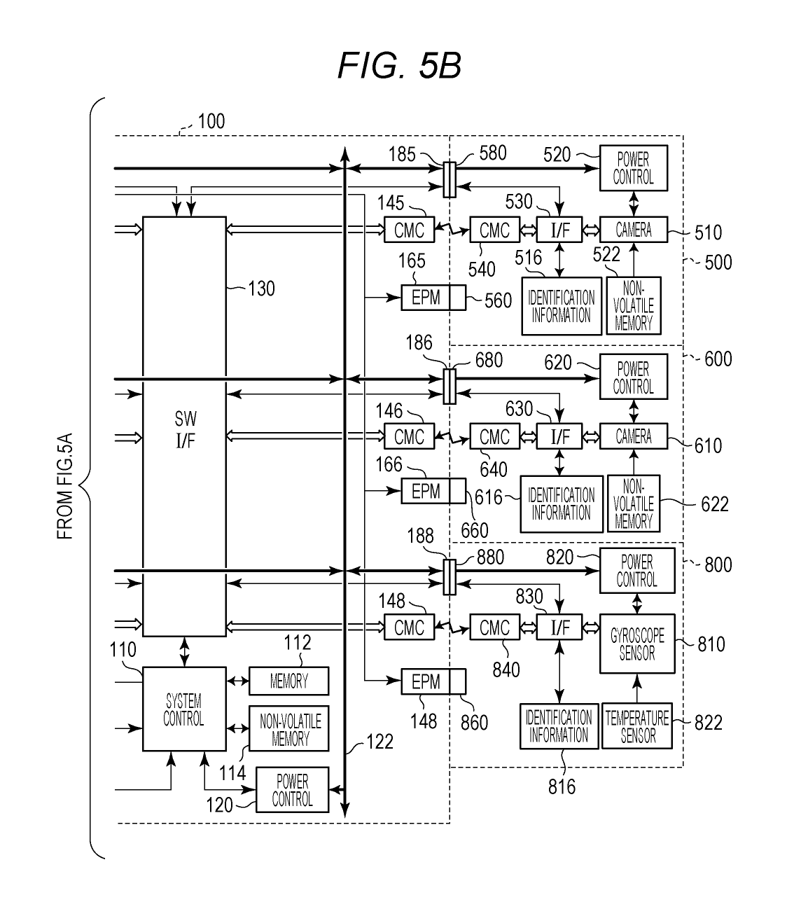

FIGS. 5A and 5B are block diagrams of a configuration example of the smart device according to the first embodiment of the present disclosure. Hereinafter, configuration examples of the smart device and various modules according to the present embodiment will be described with reference to FIGS. 5A and 5B. Note that there are a wide variety of modules attachable to the smart device body 100. A combination illustrated in FIGS. 5A and 5B is merely an example, and the present disclosure is not limited to such a combination. The modules according to the present embodiment include, but not limited to, an image pickup module, a touch panel, a power supply module, a communication module, an orientation sensing module, and an application control module, for example. Moreover, the device includes, but not limited to, a gyroscope sensor, a piezoelectric device (a motor), a tactile device (VCM), an electromagnetic motor, and a DL device, for example.

### <Configuration of Smart Device Body 100>

The smart device body 100 is configured to perform control regarding each module attached to the smart device body 100 under the integrated control of the application program control module 200. In the smart device body 100, a system control circuit 110 is configured to control the entirety of the smart device body 100. The system control circuit 110 performs collaborative operation according to an instruction or request of the application program control module 200 when various application programs are executed in environment where a kernel or an OS is executed. An application control circuit 210 included in the application program control module 200 is configured to make the above-described instruction or request for the system control circuit 110. The system control circuit 110 can operate the smart device body 100 and each module in cooperation, and can execute various services/functions of the application control circuit 210.

A memory 112 is directly accessed by the system control circuit 110 for reading and writing. A non-volatile memory 114 is configured to store a constant, a variable, and a program for operation of the system control circuit 110 and position information on each slot, for example. The non-volatile memory 114 is an electrically deletable/recordable memory, and, e.g., a flash memory is used. The position information on each slot includes position information on individual slots 1100, 1200, 1400, 1500, 1600, 1700, 1800 and 1900 provided on the back side of the smart device body 100. Moreover, for each slot, the position information specifies the coordinates of contact faces of the ribs 101 and the spine 102 for determining the position of the module upon attachment thereof. Note that in the present embodiment, the position of each module is determined by contact with the ribs 101 and the spine 102, but the present disclosure is not limited to this. For example, a protruding portion for position determination may be provided at the smart device body 100, and a recess portion to be fitted onto the protruding portion may be provided at each module. In this case, the position information on each slot includes position information on the protruding portion for position determination.

Various types of identification information necessary for communication of the smart device body 100 with each module is stored as identification information 116. A temperature sensor 118 is configured to measure the temperature of a predetermined spot of the smart device body 100. The temperature sensor 118 includes one or more temperature sensors. A power supply control circuit 120 is configured to supply predetermined necessary voltage/current to each section of the smart device body 100 via the system control circuit 110.

A power supply bus 122 is connected to the power supply control circuit 120 of the smart device body 100 and power supply terminals of connectors 182 to 186 and 188. The power supply terminals of the connectors 182 to 186 and 188 are each connected to power supply control circuits and battery control units of the modules via connectors and power supply terminals of the modules (the connectors of the modules: 280, 380, 480, 580, 680 and 880) (the power supply control circuits of the modules: 220, 320, 520, 620 and 820).

A switch interface circuit 130 is configured to switch and relay high-speed data or message communication with each module via the body-side CMCs 142 to 146 and 148. The body-side CMCs 142 to 146 and 148 perform contact close proximity communication by an inductive coupling method, and each communicate with the module-side CMCs 240, 340, 440, 540, 640 and 840 at high speed. Note that a combination of the body-side CMC 142 to 146 and 148 and the module-side CMC in the proximity thereto is, as necessary, changed according to user's intention, and the combination illustrated in the block diagrams of FIGS. 5A and 5B is merely an example.

The EPMs 162 to 166 and 168 each attract or non-attract the magnetic bodies 260, 360, 460, 560, 660 and 860 of the modules by magnetic force control. In this manner, the EPMs 162 to 166 and 168 fix (lock) or disengage (release) each module at a connection portion between the frame structure of the smart device body 100 and each module. Note that a combination of the EPM 162 to 166 and 168 and the module-side magnetic body connected thereto is, as necessary, changed according to user's intention, and the combination illustrated in the block diagrams of FIGS. 5A and 5B is merely an example.

The connectors 182 to 186 and 188 are each connected to the connectors of the modules so that a terminal group (a power bus, the ground) relating to the power supply can be mutually used between the smart device body 100 and each module. Similarly, each function such as a terminal for a detection (Detect) signal indicating attachment of the module, a terminal for a start-up (Wake) signal indicating sleep deactivation of the module, and an RF signal terminal connecting antenna wiring lines can be mutually used. The connectors 182 to 186 and 188 in this embodiment are typical compact metal terminals formed at side portions of the ribs 101 and spine 102 of the smart device body 100 (these terminals are not visible from the positions illustrated in FIGS. 1 to 3, and therefore, are not shown). Note that a combination of the connectors 182 to 186 and 188 and the module-side connector connected thereto is, as necessary, changed according to user's intention, and the combination illustrated in the block diagrams of FIGS. 5A and 5B is merely an example.

### <Configuration of Application Program Control Module 200>

The application program control module 200 performs, by operation of the application control circuit 210, integrated control of the entire system including the smart device body 100 and each module attached thereto. For example, the application control circuit 210 makes, via the system control circuit 110, an instruction/request for a display operation control circuit 310 included in the display operation module 300. The display operation control circuit 310 controls the LCD panel 312 as a display unit in response to the above-described instruction/request so that various types of information can be displayed. Moreover, the application control circuit 210 can acquire operation input information for a touch panel/button 314 as an operation input unit via the system control circuit 110 and the display operation control circuit 310 included in the display operation module 300. Then, according to such operation input contents, processing by a kernel service, an OS service, and various application programs can be executed.

A memory 212 is directly accessed by the application control circuit 210 for reading and writing. A non-volatile memory 214 is configured to store a constant, a variable, and a program for operation of the application control circuit 210, for example. The non-volatile memory 214 is an electrically deletable/recordable memory, and, e.g., a flash memory is used.

Various types of identification information necessary for communication of the application program control module 200 with the smart device body 100 and each module is stored as identification information 216. A power supply control circuit 220 is configured to supply predetermined necessary voltage/current to each section of the application program control module 200. A temperature sensor 222 is configured to measure the temperature of a predetermined spot of the application program control module 200. The temperature sensor 222 includes one or more temperature sensors. An interface circuit 230 is configured to relay high-speed data or message communication with the smart device body 100 and each module via the module-side CMC 240.

A management table 290 is configured to store information on multiple management files necessary for execution of each dedicated application program. The management file information includes the type of module essential upon execution of each dedicated application program, a corresponding module combination allowing maximum utilization of a desired function, and the most suitable slot position relationship for attachment of a corresponding module. Moreover, in the present embodiment, the type of module effective for function addition is included as the management file information although not essential for each dedicated application program. Many options are provided to a user, leading to higher convenience. Such management file information is acquired from the management table 290 by the application control circuit 210. Note that the present disclosure is not limited to such a configuration, and the management file information may be stored in the memory 212 or the non-volatile memory 214. In this case, the management file information is acquired from the memory 212 or the non-volatile memory 214 by the application control circuit 210.

### <Configuration of Display Operation Module 300>

The display operation module 300 is configured to display various types of information and acquire the operation input in response to the instruction/request of the system control circuit 110 of the smart device body 100 under the integrated control of the application program control module 200. In the display operation module 300, 310 is the display operation control circuit configured to control the entirety of the display operation module 300. The display unit 312 corresponds to a display device such as an LCD, an OLED, and a LED, and an LCD panel is employed in the present embodiment. The operation input unit 314 corresponds to an operation device such as a touch panel (TP) and an operation button. The touch panel and the operation button may be separately configured, or may be integrally configured. Note that in the present embodiment, the touch panel and the operation button are separately configured.

The display unit 312 is configured to display various types of information for the user by the display operation control circuit 310 according to the instruction of the application control circuit 210 of the application program control module 200. Moreover, input operation for the operation input unit 314 by the user, such as touch panel operation or button operation, and a sound signal detected by the microphone 318 are transmitted to the application control circuit 210 via the display operation control circuit 310.

Various types of identification information necessary for communication of the display operation module 300 with the smart device body 100 and each module is stored as identification information 316. A power supply control circuit 320 is configured to supply predetermined necessary voltage/current to each section of the display operation module 300. A temperature sensor 322 is configured to measure the temperature of a predetermined spot of the display operation module 300. The temperature sensor 322 includes one or more temperature sensors. An interface circuit 330 is configured to relay high-speed data or message communication with the smart device body 100 and each module via the module-side CMC 340.

### <Configuration of Power Supply Module 400>

The power supply module 400 is configured to discharge/charge a battery 420 via the system control circuit 110 and the power supply bus 122 of the smart device body 100 under the integrated control of the application program control module 200. In the power supply module 400, a power supply control circuit 410 is configured to control, including discharge/charge control of the battery 420, the entirety of the power supply module 400, thereby supplying predetermined necessary voltage/current to each section of the power supply module 400. Various types of identification information necessary for communication of the power supply module 400 with the smart device body 100 and each module is stored as identification information 416.

The battery 420 corresponds to a Li-ion battery, a fuel battery, etc. The battery 420 is configured to discharge to the smart device body 100 and each module via the connector 480 by the power supply control circuit 410 and to charge from the smart device body 100 and a not-shown charging module. A temperature sensor 422 is configured to measure the temperature of a predetermined spot of the power supply module 400. The temperature sensor 422 includes one or more temperature sensors. An interface circuit 430 is configured to relay high-speed data or message communication with the smart device body 100 and each module via the module-side CMC 440.

### <Configuration of First Image Pickup Module 500>

The first image pickup module 500 is controlled by the system control circuit 110 of the smart device body 100 under the integrated control of the application program control module 200, thereby performing desired image pickup processing. In the first image pickup module 500, 510 is a first camera configured such that multiple optical lenses are arranged on an optical axis. Further, the first camera 510 includes a diaphragm mechanism configured to adjust the quantity of passing light, an AF mechanism configured to move at least one optical lens in an optical axis direction to perform focusing, and a lens barrel housing these components on the inside. Moreover, the first camera 510 includes an image pickup sensor configured to obtain image data by photoelectric conversion, an image processing circuit configured to process the image data, and a drive control circuit configured to control each mechanism.

The first camera 510 implements control such as automatic exposure adjustment (AE) for setting the most suitable diaphragm or shutter speed or image pickup sensor sensitivity, automatic focusing (AF) according to an object distance, and automatic white balancing (AWB) for adjusting a color temperature to reproduce a suitable color tone. In addition, in the present embodiment, camera shake is calculated from the angular velocity information acquired by the orientation sensing module 800, and an exposure range cut out on the image pickup sensor is followed up. In this manner, camera shake correction (IS) can be performed in a simple manner. Note that the present disclosure is not limited to such a typical image pickup apparatus control method, and this method has been already well-known from the prior art literatures and the like. Thus, separate detailed description will not be made.

The first camera 510 is instructed according to the application program executed by the application control circuit 210 or the input to the operation input unit 314 of the display operation module 300. The image data acquired by the first camera 510 can be displayed on the display unit 312 in such a manner that the application control circuit 210 controls the system control circuit 110 of the smart device body 100 and the display operation module 300.

Various types of identification information necessary for communication of the first image pickup module 500 with the smart device body 100 and each module is stored as identification information 516. A power supply control circuit 520 is configured to supply predetermined necessary voltage/current to each section of the first image pickup module 500.

A non-volatile memory 522 is configured to store, e.g., a constant, a variable, and a frequency for operation of the first camera 510, component position information, optical axis error information, and lens error information. The non-volatile memory 522 is an electrically deletable/recordable memory, and, e.g., a flash memory is used. The component position information described herein includes optical axis coordinate information as viewed from the external form of the first image pickup module 500. As described above, the position of the first image pickup module 500 is determined in such a manner that the external form of the first image pickup module 500 contacts the smart device body 100. Note that in the present embodiment, the position of the first image pickup module 500 is determined by contact with the ribs 101 and spine 102 of the smart device body 100, but the present disclosure is not limited to this. For example, a protruding portion for position determination may be provided at the smart device body 100, and a recess portion to be fitted onto the protruding portion may be provided at the first image pickup module 500. In this case, the component position information includes optical axis coordinate information as viewed from the recess portion fitted onto the protruding portion.

An interface circuit 530 is configured to relay high-speed data or message communication with the smart device body 100 and each module via the module-side CMC 540.

<Configuration of Second Image Pickup Module 600>

The second image pickup module 600 is controlled by the system control circuit 110 of the smart device body 100 under the integrated control of the application program control module 200, thereby performing desired image pickup processing. In the second image pickup module 600, 610 is a second camera configured such that multiple optical lenses are arranged on an optical axis. Further, the second camera 610 includes a diaphragm mechanism configured to adjust the quantity of passing light, an AF mechanism configured to move at least one optical lens in an optical axis direction to perform focusing, and a lens barrel housing these components on the inside. Moreover, the second camera 610 includes an image pickup sensor configured to obtain image data by photoelectric conversion, an image processing circuit configured to process the image data, and a drive control circuit configured to control each mechanism. These components of the second camera 610 are similar to those of the above-described first camera 510. However, the arrangement and shape of the second camera 610 in the second image pickup module 600 are different from those of the first camera 510 in the first image pickup module 500.

In the present embodiment, the second camera 610 can perform image pickup control similar to that of the first camera 510.

The second camera 610 is instructed according to the application program executed by the application control circuit 210 or the input to the operation input unit 314 of the display operation module 300. The image data acquired by the second camera 610 can be displayed on the display unit 312 in such a manner that the application control circuit 210 controls the system control circuit 110 of the smart device body 100 and the display operation module 300.

Various types of identification information necessary for communication of the second image pickup module 600 with the smart device body 100 and each module is stored as identification information 616. A power supply control circuit 620 is configured to supply predetermined necessary voltage/current to each section of the second image pickup module 600.

A non-volatile memory 622 is configured to store, e.g., a constant, a variable, and a frequency for operation of the second camera 610, component position information, optical axis error information, and lens error information. The non-volatile memory 622 is an electrically deletable/recordable memory, and, e.g., a flash memory is used. The component position information described herein includes optical axis coordinate information as viewed from the external form of the second image pickup module 600. As described above, the position of the second image pickup module 600 is determined in such a manner that the external form of the second image pickup module 600 contacts the smart device body 100. Note that in the present embodiment, the position of the second image pickup module 600 is determined by contact with the ribs 101 and spine 102 of the smart device body 100, but the present disclosure is not limited to this. For example, a protruding portion for position determination may be provided at the smart device body 100, and a recess portion to be fitted onto the protruding portion may be provided at the second image pickup module 600. In this case, the component position information includes optical axis coordinate information as viewed from the recess portion fitted onto the protruding portion.

An interface circuit 630 is configured to relay high-speed data or message communication with the smart device body 100 and each module via the module-side CMC 640.

### <Configuration of Orientation Sensing Module 800>

The orientation sensing module 800 is controlled by the system control circuit 110 of the smart device body 100 under the integrated control of the application program control module 200, thereby sensing the orientation of the smart device. In the orientation sensing module 800, a gyroscope sensor 810 is configured to acquire the angular velocity information from the three-axis gyroscope sensor.

Various types of identification information necessary for communication of the orientation sensing module 800 with the smart device body 100 and each module is stored as identification information 816. A power supply control circuit 820 is configured to supply predetermined necessary voltage/current to each section of the orientation sensing module 800. A temperature sensor 822 is configured to measure the temperature of a predetermined spot of the orientation sensing module 800. The temperature sensor 822 includes one or more temperature sensors.

An interface circuit 830 is configured to relay high-speed data or message communication with the smart device body 100 and each module via the module-side CMC 840. The interface circuit 830 transmits the angular velocity information acquired by the gyroscope sensor 810 to the smart device body 100. Further, the smart device body 100 transfers the data to the application program control module 200 at high speed. In this manner, the angular velocity information of the orientation sensing module 800 is used for switching of a display direction in the display operation module 300 and camera shake correction in the first image pickup module 500 and the second image pickup module 600, for example.

Note that the management table 290 provided in the application program control module 200 illustrated in FIGS. 5A and 5B can update, by the wireless LAN module 700 and the like, the information at the time of updating the application program. Thus, in the management table 290 in FIG. 5A, the type of module, an implementable module function, and other types of necessary information can be, as necessary, changed or added.

### <Description of Operation of Application Program Control Module 200>

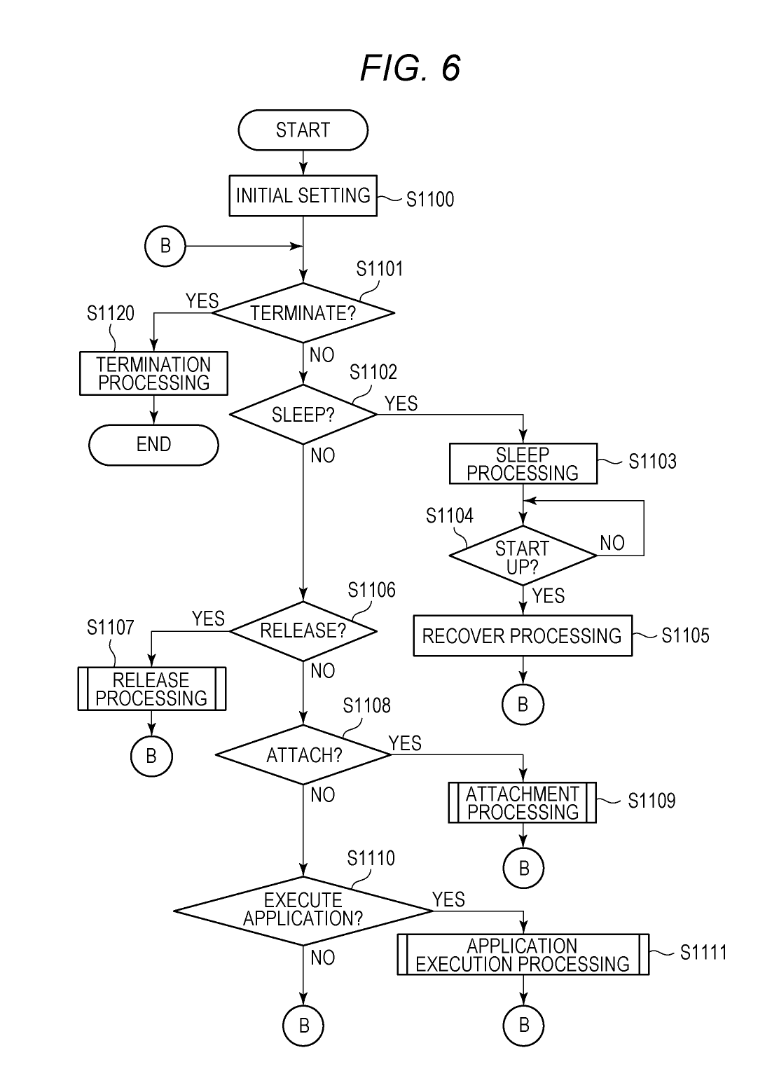

FIG. 6 is a flowchart of a main routine of the application program control module according to the first embodiment of the present disclosure. The flowchart of FIG. 6 illustrates a processing procedure executed by control of each processing block by the application control circuit 210. An operation flow of the main routine of the application program control module 200 in operation of the smart device described with reference to FIGS. 5A and 5B is mainly illustrated. Operation of the application program control module 200 of the present embodiment will be described with reference to FIGS. 5 to 6.

In an initial power OFF state, the application program control module 200, the smart device body 100, and the display operation module 300 are in an operation termination state for operation with low power consumption. In this state, when the user operates the power supply button 314a of the display operation module 300, the display operation control circuit 310 transmits the start-up (Wake) signal indicating sleep deactivation to the application control circuit 210. When receiving the start-up (Wake) signal from the display operation control circuit 310, the application control circuit 210 executes initial setting at a step S1100. Moreover, in the present embodiment, the terminals for the detection (Detect) signal are provided at the connector sections of all modules. For example, when a new module is attached to an available slot, the detection (Detect) signal is also transmitted, and the processing transitions to the step S1100.

At the step S1100, the application control circuit 210 resets and initializes a predetermined flag, a predetermined control variable, etc., and initializes each section of the application program control module 200. Subsequently, the application control circuit 210 executes a software program read out from the non-volatile memory 214, thereby sequentially starting up the kernel and the OS. Thereafter, communication with the system control circuit 110 of the smart device body 100 is initialized via the interface circuit 230, the module-side CMC 240, the body-side CMC 142, and the switch interface circuit 130. All modules are brought into an operable state by initialization of the system control circuit 110. For example, in the display operation module 300, the display operation control circuit 310 displays a predetermined start-up screen on the LCD panel 312 as the display unit. Then, the display operation module 300 reaches such a state that the user can input an instruction to the operation input unit 314 such as the touch panel and the button.

After the step S1100 has ended, the processing proceeds to a step S1101. At this point, if the user inputs an instruction for transition to the termination state, the display operation control circuit 310 transmits a termination message to the application control circuit 210. When receiving the termination message, the application control circuit 210 determines transition of the smart device to the termination state.

When the termination message for transition to the termination state is received at the step S1101, the processing proceeds to a step S1120. At the step S1120, the application control circuit 210 transmits the termination message to the system control circuit 110, and then, saves the flag, the control variable, etc. in the non-volatile memory 214 as necessary. In addition, the OS and the kernel transition to the operation termination state for operation with low power consumption. Then, the termination processing of changing a power supply to the application program control module 200, the smart device body 100, and the display operation module 300 via the power supply control circuit 220 to a low power consumption setting is performed. When receiving the termination message, the system control circuit 110 performs the processing of stopping operation of all modules other than the application program control module 200, the smart device body 100, and the display operation module 300. When the step S1120 ends, the application control circuit 210 terminates the main routine of the application program control module 200, and reaches a so-called power OFF state.

In a case where the termination message for transition to the termination state is not received at the step S1101, the processing proceeds to a step S1102. At the step S1102, the application control circuit 210 determines whether or not a sleep message for transition to a sleep state has been received from the display operation control circuit 310 of the display operation module 300. The display operation control circuit 310 displays information regarding sleep processing on the LCD panel 312 as the display unit so that the user can input an instruction to the operation input unit 314 such as the touch panel and the button. At this point, if the user inputs the instruction for transition to the sleep state, the display operation control circuit 310 transmits the sleep message for transition to the sleep state to the application control circuit 210.

When the sleep message for transition to the sleep state is received at the step S1102, the processing proceeds to a step S1103. At the step S1103, the application control circuit 210 transmits the sleep message to the system control circuit 110, and then, saves the flag, the control variable, etc. in the non-volatile memory 214 as necessary. In addition, the OS and the kernel transition to a sleep operation state for operation with low power consumption. Then, when receiving the sleep message, the system control circuit 110 performs the processing of causing operation of all modules of the smart device to transition to the sleep state.

Similarly, in a case where the user's instruction input to the display operation module 300 or the start-up (Wake) signal transmitted from each module is not received even after a lapse of a predetermined time, the processing also proceeds to the step S1103. At the step S1102, the application control circuit 210 performs integration of the time elapsed after the timing of recently receiving the input instruction or the start-up (Wake) signal. As a result of comparison of the integrated time with a predetermined value, when the integrated time is longer, transition to the above-described sleep state is made.

At a step S1104, the application control circuit 210 determines whether or not the start-up (Wake) signal transmitted from each module has been received via the connector 280. When the start-up (Wake) signal is not received at the step S1104, the sleep operation state is continued until the start-up (Wake) signal is received. The sleep operation state described in the present embodiment is different from the above-described power OFF state. For example, when the movable member communication module 900 receives an invoking signal according to a movable member communication standard, the application control circuit 210 promptly causes the smart device to transition from the sleep operation state to a predetermined application execution state. Note that such typical control for a movable member wireless communication system has been already well-known, and therefore, detailed description thereof will not be made.

When the start-up (Wake) signal is received at the step S1104, the processing proceeds to a step S1105. At the step S1105, the application control circuit 210 recovers the flag, the control variable, etc. from the non-volatile memory 214 as necessary. In addition, the recover processing of causing the OS and the kernel to transition to a normal operation state for operation with normal power consumption and changing a power supply to all modules of the smart device via the power supply control circuit 220 to a normal power consumption setting is performed. Further, at the step S1105, the application control circuit 210 performs the recover processing for communication with the system control circuit 110 of the smart device body 100. At this point, the system control circuit 110 performs the recover processing for all modules other than the application program control module 200, and causes the smart device to transition to the normal operation state. The processing returns to the step S1101.

In a case where the sleep message for transition to the sleep state is not received at the step S1102, the processing proceeds to a step S1106. At the step S1106, the application control circuit 210 determines whether or not a release message has been received from the display operation control circuit 310 of the display operation module 300. The display operation control circuit 310 displays information regarding release processing on the LCD panel 312 as the display unit so that the user can input an instruction to the operation input unit 314 such as the touch panel and the button. If the user inputs the instruction for the release processing for detaching any module, the display operation control circuit 310 transmits a release message for transition to a release state to the application control circuit 210.

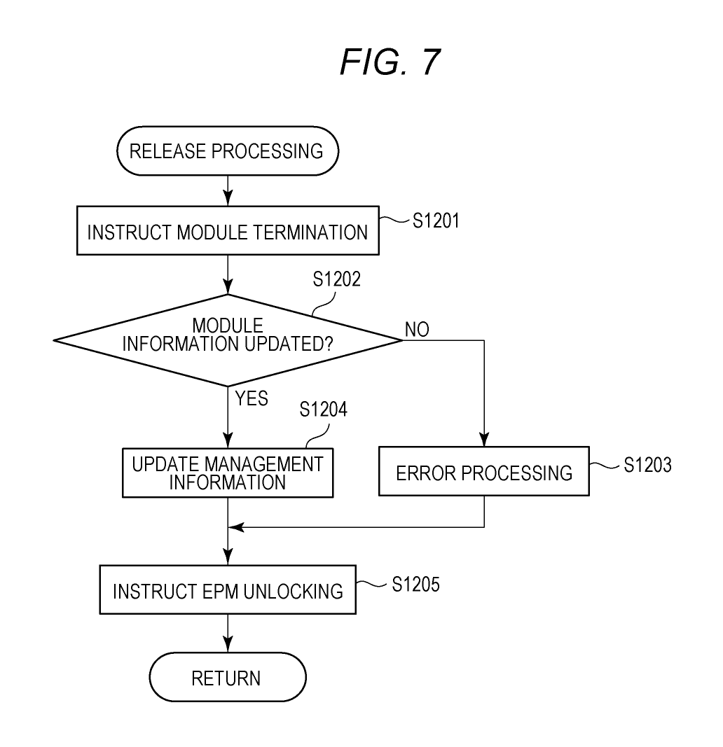

When the release message for transition to the release state is received at the step S1106, the processing proceeds to a step S1107. At the step S1107, the application control circuit 210 executes the release processing of normally terminating the function of the module targeted for detachment by the user to disengage the EPM. Details of the release processing will be described later with reference to FIG. 7. When the step S1107 is terminated, the processing returns to the step S1101.

When the release message for transition to the release state is not received at the step S1106, the processing proceeds to a step S1108. At the step S1108, the application control circuit 210 determines whether or not the detection (Detect) signal for each module has been received. The detection (Detect) signal described herein indicates detection of new attachment of each module to the smart device body 100, and is an electrical signal transmitted to the application control circuit 210 by the system control circuit 110.

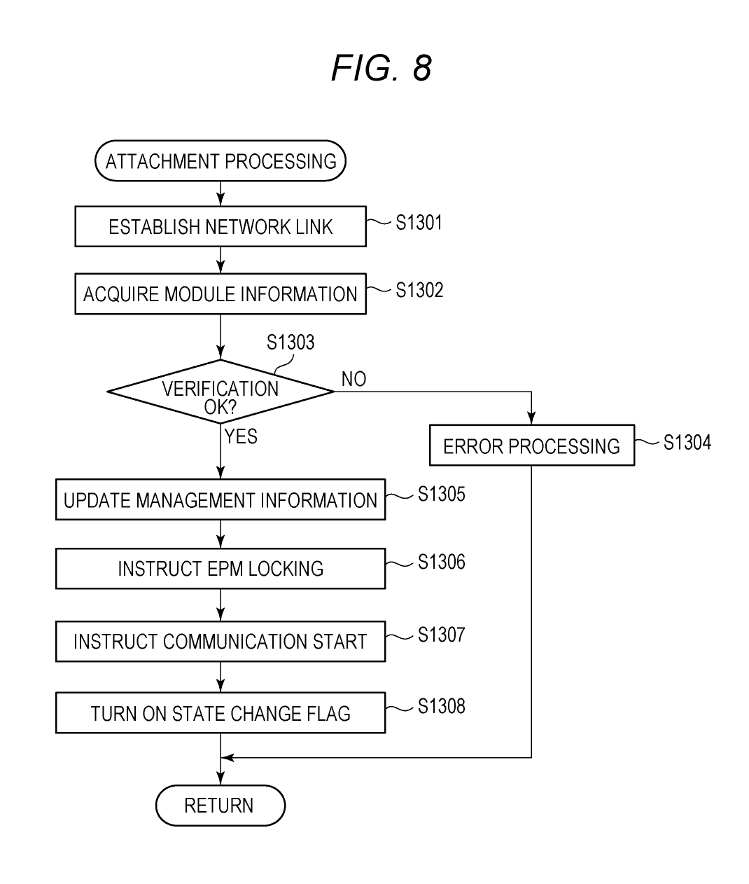

When the detection (Detect) signal is received at the step S1108, the processing proceeds to a step S1109. At the step S1109, the application control circuit 210 executes the module setting processing of fixing a corresponding module inserted into the smart device body 100 and causing such a module to properly function. Details of the module setting processing will be described later with reference to FIG. 8. When the step S1109 is terminated, the processing returns to the step S1101.

When the detection (Detect) signal is not received at the step S1108, the processing proceeds to a step S1110. At the step S1110, the application control circuit 210 determines whether or not an application program relating message has been received from the display operation control circuit 310 of the display operation module 300. In the display operation module 300, the display operation control circuit 310 displays information regarding the sleep processing on the LCD panel 312 as the display unit. The user can input an instruction to the operation input unit 314 such as the touch panel and the button. Thus, when the user inputs, e.g., an instruction for execution regarding a predetermined application program, the display operation control circuit 310 transmits the application program relating message to the application control circuit 210.

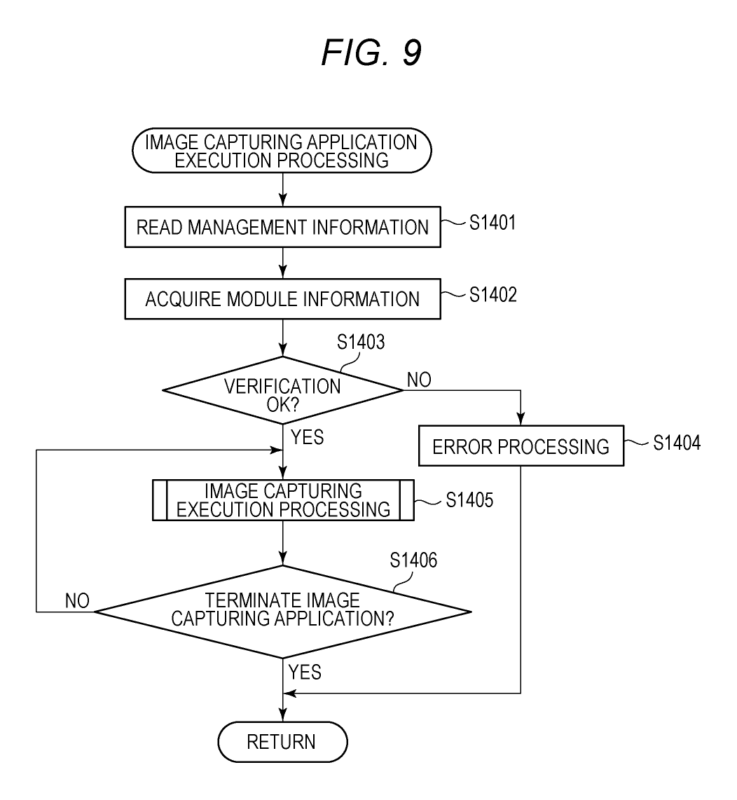

When the application program relating message is received at the step S1110, the processing proceeds to a step S1111, and the application control circuit 210 executes application program execution processing at the step S1111. The application program assumed in the present embodiment includes various functions implementable by a combination with each module. For example, the call function is available by a combination with the movable member communication module 900, and web browsing via Internet connection is available by a combination with the wireless LAN module 700. Moreover, the typical image capturing function is implemented only by the first image pickup module 500, and by a combination of the first image pickup module 500 with the second image pickup module 600, the image composition function and the image measurement function as the compound-eye camera functions are implemented. Details of image capturing application execution processing as an example of these application programs will be described later with reference to FIG. 9. When the step S1111 is terminated, the processing returns to the step S1101.

When the application program relating message is not received at the step S1110, the processing returns to the step S1101 to repeat similar operation.

FIG. 7 is a flowchart of an operation flow of the module release processing executed at the step S1107 of FIG. 6. The flowchart of FIG. 7 illustrates a processing procedure executed by control of each processing block by the application control circuit 210.

At a step S1201 of FIG. 7, the application control circuit 210 transmits a message for instructing termination of the function of the module to the system control circuit 110. Next, the processing proceeds to a step S1202, and the application control circuit 210 determines whether or not an information update message transmitted from the system control circuit 110 and notifying that module information is updated has been received.

When the information update message is not received at the step S1202, the application control circuit 210 performs predetermined error processing at a step S1203. Thereafter, the EPM is controlled at a step S1205 such that a module lock state is cancelled to terminate a release processing routine. In the error processing, error contents may be displayed on, e.g., the display operation module 300 to notify the user of such error contents.

When the information updating message is received at the step S1202, the processing proceeds to a step S1204. At the step S1204, the application control circuit 210 updates, according to the contents received from the system control circuit 110, management information stored in predetermined areas of the non-volatile memory 214 and the memory 212 managed by the OS and the kernel. The management information described herein includes module management information, EPM control management information, and RF bus configuration management information. Thereafter, the EPM is controlled at the step S1205 such that the module lock state is cancelled to terminate the release processing routine.

FIG. 8 is a flowchart of an operation flow of the module attachment processing executed at the step S1109 of FIG. 6. The flowchart of FIG. 8 illustrates a processing procedure executed by control of each processing block by the application control circuit 210.

At a step S1301 of FIG. 8, the application control circuit 210 and the system control circuit 110 together perform message communication connection setup, thereby establishing a network link with the system control circuit 110. Next, the processing proceeds to a step S1302, and the application control circuit 210 acquires the module information such as initialization from a corresponding module via the system control circuit 110. Further, the processing proceeds to a step S1303, and the application control circuit 210 verifies and determines, based on the module information acquired at the step S1302, whether or not the attached module has contents causing no problem on the smart device. The module information includes information on the module, such as device information, a communication capacity, a frequency used for driving or detection, and voltage necessary for driving. Verification is, for example, performed regarding whether or not stable communication is available, whether or not operation is available with the voltage of the already-attached power supply module 400, and whether or not a standard set separately for the smart device is satisfied if any.

When there is a problem on a determination result verified at the step S1303, the application control circuit 210 performs predetermined error processing at a step S1304, and then, terminates a module attachment processing routine. In the error processing, error contents and the like may be displayed on, e.g., the display operation module 300 to notify the user of the error contents.

When there is no problem on the determination result verified at the step S1303, the processing proceeds to a step S1305. At the step S1305, the application control circuit 210 updates, based on the module information on a corresponding module targeted for initialization, the management information stored in the predetermined areas of the non-volatile memory 214 and the memory 212. The management information described herein includes module management information, EPM control management information, and RF bus configuration management information.

Next, at a step S1306, the application control circuit 210 transmits, to the system control circuit 110, an EPM lock instruction message for the corresponding module targeted for initialization. In this manner, the smart device body 100 and the corresponding module targeted for initialization are fixed and brought into a lock state by the EPM.

Subsequently, the application control circuit 210 transmits, at a step S1307, a communication start instruction message to the system control circuit 110, and notifies that message communication with the corresponding module subjected to a series of initialization processing is available. Thereafter, at a step S1308, a state change flag is switched to ON to terminate the module attachment processing routine. The state change flag described herein is a reprocessing flag assigned corresponding to each module and switched between ON and OFF by the presence/absence of a change in the state of each module. When the state of each module attached to the smart device body 100 is changed, the state change flag is turned ON. Note that the state change includes, in addition to attachment of each module, a change in a remaining battery level, failure, and performance degradation.

By the module attachment processing routine, a normal module is attached to the smart device body 100. Further, such a module is reliably locked by the EPM, and is brought into a state in which the function of the corresponding module is available. Note that for stabilizing each type of communication, the control of locking the module by the EPM before the step S1301 may be performed. In this case, unlocking is performed after the step S1304.

FIG. 9 is a flowchart of an operation flow of the image capturing application execution processing as the example of the dedicated application program executed at the step S1111 of FIG. 6. The flowchart of FIG. 9 illustrates a processing procedure executed by control of each processing block by the application control circuit 210.

In FIG. 9, when an image capturing application is first launched by operation input of the display operation module 300 at a step S1401, the application control circuit 210 acquires the management file information on the image capturing application from the management table 290. At this point, the management file information includes the type of module essential for execution of the image capturing application, a corresponding module combination allowing maximum utilization of the image capturing function, and the most suitable slot position relationship for attachment of a corresponding module.

Next, the processing proceeds to a step S1402, and the application control circuit 210 acquires the module information from each module via the system control circuit 110.

Then, at a step S1403, verification and determination are, based on the management file information on an image pickup application, made on whether or not a necessary module is attached and whether or not there is a problem on such a combination, for example. When there is a problem on a determination result verified at the step S1403, the application control circuit 210 performs predetermined error processing at a step S1404, and then, an image capturing application execution processing routine is terminated. In the error processing, it may be configured such that error contents and the like are displayed on, e.g., the display operation module 300 to notify the user of the error contents. In this manner, module replacement is suggested.

For example, in a case where the image pickup module is not attached to any slot at the time of the step S1402 and the image pickup application cannot be executed, error contents are notified in the error processing of the step S1404, and the image capturing application execution processing routine is terminated. In addition, when the orientation sensing module 800 is not attached even in a case where the attached image pickup module 500 has the camera shake correction (IS) function, camera shake cannot be sensed, for example. In this case, the camera shake correction (IS) function as part of the image capturing function is limited in the error processing of the step S1404. In this case, the image capturing application execution processing routine is not necessarily terminated. With, e.g., user's operation input in response to notification of the error contents, the processing may transition to image capturing execution processing of a step S1405 according to situation.

With no problem on the result verified at the step S1403, the processing proceeds to the step S1405 to perform the image capturing execution processing. When the step S1405 is terminated, the processing proceeds to a step S1406. At the step S1406, an image capturing application termination message is not received, the processing returns to the step S1405 to repeat the image capturing execution processing.

When the user inputs an instruction to terminate the image capturing application execution processing at the step S1406, the display operation control circuit 310 transmits the image capturing application termination message to the application control circuit 210. When the application control circuit 210 receives the image capturing application termination message, transition to a dedicated application program termination state is determined, and operation of a corresponding module is stopped. Then, the image capturing application execution processing routine is terminated.

As described above, in the first embodiment, verification of the attached module upon execution of the image capturing application in the smart device configured so that the multiple modules can be combined and the error processing based on the verification result have been described.

### Second Embodiment

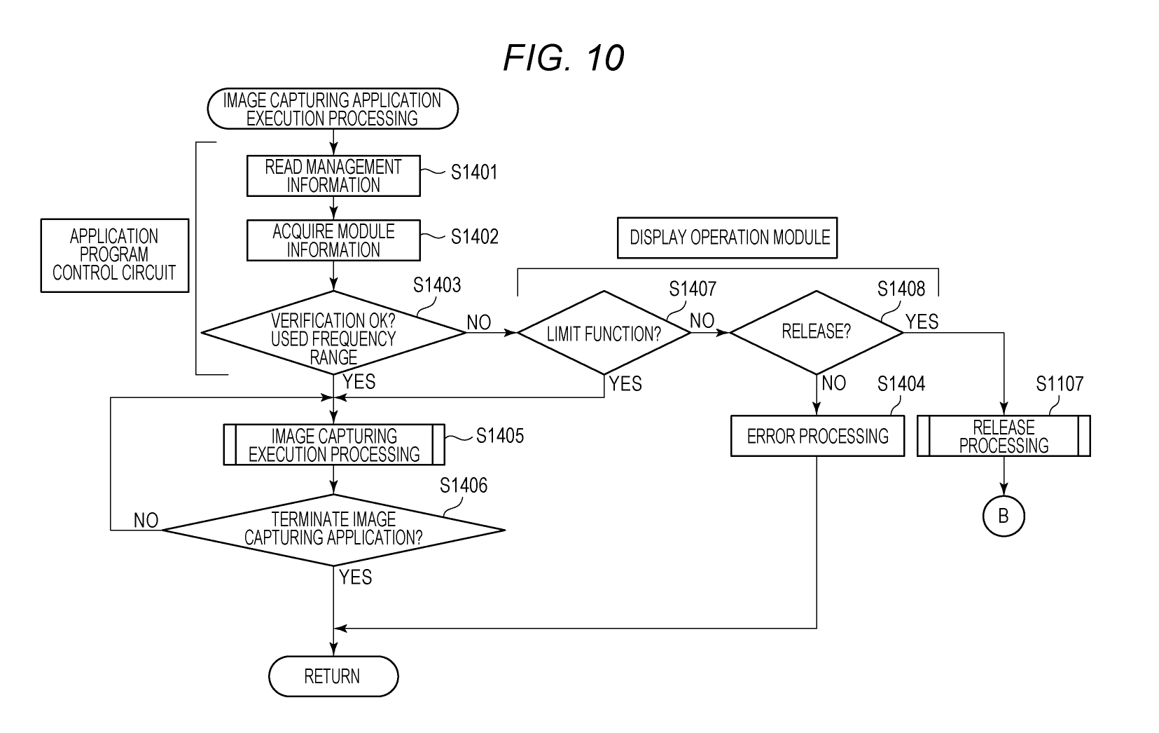

Next, operation verification based on image pickup application management file information and error processing according to a verification result will be described as a second embodiment. FIG. 10 is a flowchart of used frequency verification according to the second embodiment of the present disclosure. Note that the same step numbers are used to represent the same steps as those of the flowchart illustrated in FIG. 9, and description thereof will not be repeated. The flowchart of FIG. 10 illustrates a processing procedure executed by control of each processing block by an application control circuit 210. As in FIG. 9, module information is acquired at S1402, and in operation verification of a step S1403, operation verification based on the module information is, in the present embodiment, also performed in addition to operation verification based on the management information in the flowchart of FIG. 9. The module information includes information on a module, such as device information, a communication capacity, a frequency used for driving or detection, and voltage necessary for driving.

At the step S1403, from the module information acquired at the step S1402, it is determined whether or not multiple modules equipped with devices such as a piezoelectric device and a gyroscope sensor are attached. In the case of detecting attachment of the multiple devices, the presence/absence of interference of used frequency ranges among the modules is checked based on used frequency information contained in the modules, and it is determined whether or not the used frequency ranges overlap with each other. Specifically, a case where an orientation sensing module 800 and a first image pickup module 500 are attached will be described, for example. In this case, a case where a frequency range used by a piezoelectric device mounted for auto focusing on the first image pickup module 500 and a frequency range used by a gyroscope sensor of the orientation sensing module 800 overlap with each other is assumed. In this case, even though vibration of the piezoelectric device is vibration not targeted for detection, such vibration is synthesized with a “camera shake” correction target signal, and is detected by the gyroscope sensor. This leads to a probability that erroneous correction driving is performed. In this case, verification is NG, and the processing proceeds to a step S1407. Note that in a case where verification is OK, processing similar to that of the flowchart of FIG. 9 is performed.

When verification is NG and the processing proceeds to the step S1407, it is determined whether or not the function of the module can be limited to avoid used frequency interference with other modules. For example, in the case of interference between the piezoelectric device and the gyroscope sensor as described above, a lens is fixed at the center to limit (stop) a camera shake correction (IS) function based on a gyroscope sensor signal. Alternatively, instead of the gyroscope sensor, camera shake correction may be performed by means of another camera shake detection unit such as a motion vector based on an image. In a case where the function can be limited, an image capturing application execution processing routine is not necessarily terminated. The processing proceeds to a step S1405 to perform image capturing execution processing. At this point, it may be configured such that limitation of the function based on a determination result is notified to a user via a display module and the like and the user can select availability of function limitation in response to such notification. In the case of not allowing function limitation, such as a case where the user does not select to limit the function, the processing proceeds to a step S1408.

At the step S1408, notification is made via the display module and the like to prompt the user to replace the module. When the user selects to release the module and a release message for transition to a release state is received, the processing proceeds to a step S1107. As in the above-described step S1107, the release processing of normally terminating the function of the module targeted for detachment to disengage an EPM is executed. Moreover, in a case where the user does not select to release the module, predetermined error processing is performed, and then, the image capturing application execution processing routine is terminated as in the above-described step S1404.

The case where the frequencies of the piezoelectric device of the drive system and the gyroscope sensor interfere with each other has been described above by way of example. A case where the orientation sensing module 800 and a display operation module 300 having a touch panel function are attached will be described as another specific example. In this case, a case where a frequency range used by a tactile device piezoelectric device mounted on the display operation module 300 and the frequency range used by the gyroscope sensor of the orientation sensing module 800 overlap with each other is assumed. In this case, vibration of the piezoelectric device is synthesized with the “camera shake” correction target signal as described above, leading to a probability that erroneous correction driving is performed. Thus, in this case, operation by the touch panel is limited. For example, in a case where “camera shake” correction is ON during capturing of motion image, operation by the touch panel, such as zoom driving, focus driving, and shutter driving, is inhibited. It may be configured such that function limitation is, as described above, notified to the user and the user determines the availability according to user operation.

According to the above-described second embodiment, in a case where the multiple modules interfere with each other, favorable image capturing can be performed in such a manner that the function of the interfering module is limited or stopped. Moreover, in this case, the user can make, by notification to the user, an appropriate response such as module replacement to execute the function.

### Third Embodiment

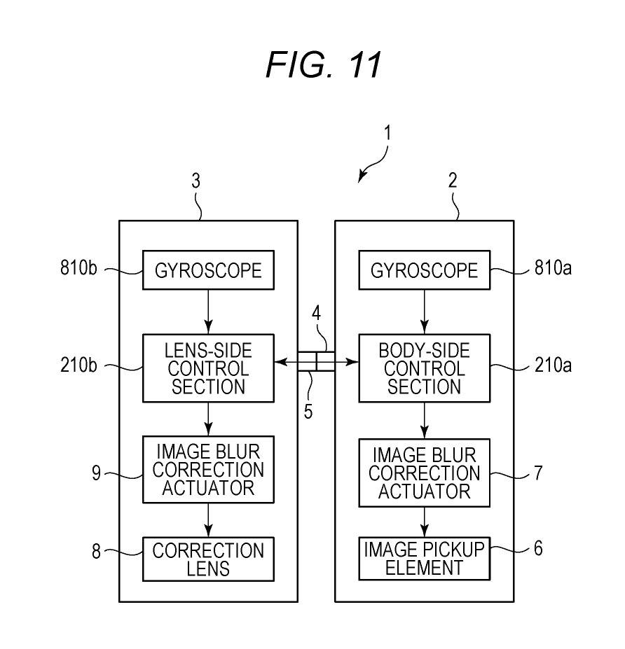

FIG. 11 is a block diagram of a configuration example of a camera system according to a third embodiment of the present disclosure. For the camera system 1, the configuration example according to an image blur prevention function in a camera body 2 and a lens unit 3 is illustrated. Each of the camera body 2 and the lens unit 3 is provided with a gyroscope sensor (810a, 810b) and a piezoelectric device as an image blur correction actuator (7, 9). The camera body 2 and the lens unit 3 each control an image pickup element 6 and a correction lens 8 to correct an image blur. The presence/absence of interference of used frequency ranges between modules is checked. In a case where the used frequency ranges do not overlap with each other, the camera body 2 and the lens unit 3 move, based on detection signals of the gyroscope sensors (810a, 810b), the image pickup element 6 and the correction lens 8 to correct the image blur. Correction can be made by both of the image pickup element 6 and the correction lens 8, and such cooperation can perform greater angular vibration control.

The body-side gyroscope sensor 810a is arranged in the camera body 2 to detect vibration due to rotation of the camera body 2 in a three-axis direction (a yaw direction, a pitch direction, a roll direction). The inclination angular velocity of the optical axis of the camera body 2 is detected, and is transmitted to a body-side control section 210a.

Meanwhile, information regarding the focal length of the lens unit 3 is input to the body-side control section 210a via a lens-side mount connector 5 and a body-side mount connector 4.

The body-side control section 210a has a function similar to that of the application control circuit 210 of the smart device of the first and second embodiments, and is configured to control the entirety of the camera body 2. Yaw-direction, pitch-direction, and roll-direction angular velocity detection signals input to the body-side control section 210a is subjected to integration processing in the body-side control section 210a, and a vibration angle in each direction is calculated. Moreover, based on the focal length input from the lens unit 3, the calculated vibration angle in each direction is converted into the extent of movement of an object image on a light receiving face of the image pickup element 6. Then, the image blur correction actuator (an image pickup element actuator) 7 is controlled to perform the angular vibration control of shifting the image pickup element 6 by the same distance as the extent of movement of the object image to correct vibration due to rotation of the camera body 2.

The lens-side gyroscope sensor 810b is configured to detect the inclination angular velocity of the optical axis of the lens unit 3 for detecting vibration due to rotation in the three-axis direction (the yaw direction, the pitch direction, the roll direction) of the lens unit 3, thereby transmitting the inclination angular velocity to a lens-side control section 210b.

The lens-side control section 210b performs the integration processing for the input yaw-direction, pitch-direction, and roll-direction angular velocity detection signals, thereby calculating the vibration angle in each direction. Then, the shift amount of the image blur correction lens 8 corresponding to the calculated vibration angle is calculated. The image blur correction actuator 9 is controlled to perform the angular vibration control of moving the image blur correction lens 8 by the calculated shift amount to correct vibration due to rotation of the lens unit 3.

The detection signal of the lens-side gyroscope sensor 810b is also transmitted to the body-side control section 210a via the lens-side control section 210b. For angular vibration control amounts on a camera body 2 side and a lens unit 3 side, the most suitable amounts are, as necessary, calculated in the body-side control section 210a based on the information sent via the lens-side control section 210b and the information of the body-side control section 210a. Then, the angular vibration control for each of the camera body 2 and the lens unit 3 is executed. In the case of a small angular vibration control amount, both of the camera body 2 and the lens unit 3 are not operated, but one of the camera body 2 or the lens unit 3 is operated because it is advantageous in terms of power saving and the like.

In the present embodiment, in a case where the used frequency ranges of the gyroscope sensors (810a, 810b) overlap with each other, some of the functions of the camera body 2 and the lens unit 3 are limited such that the used frequency ranges do not overlap with each other. In one of specific examples, the functions of the image blur correction actuator (the image pickup element actuator) 7 and the gyroscope sensor 810a mounted on the camera body 2 are stopped. The correction lens 8 is moved by the shift amount corresponding to the vibration angle calculated based on the detection signal of the lens-side gyroscope sensor 810b, thereby executing the angular vibration control. Since correction is made only by the correction lens 8, the angular vibration control amount is smaller than that in the case of correction by both of the camera body 2 and the lens unit 3.

In the third embodiment, the processing in the case where the device frequencies interfere with each other not in a detachable module structure but in the configuration of the lens unit replaceable with the camera body has been described above.

### Fourth Embodiment

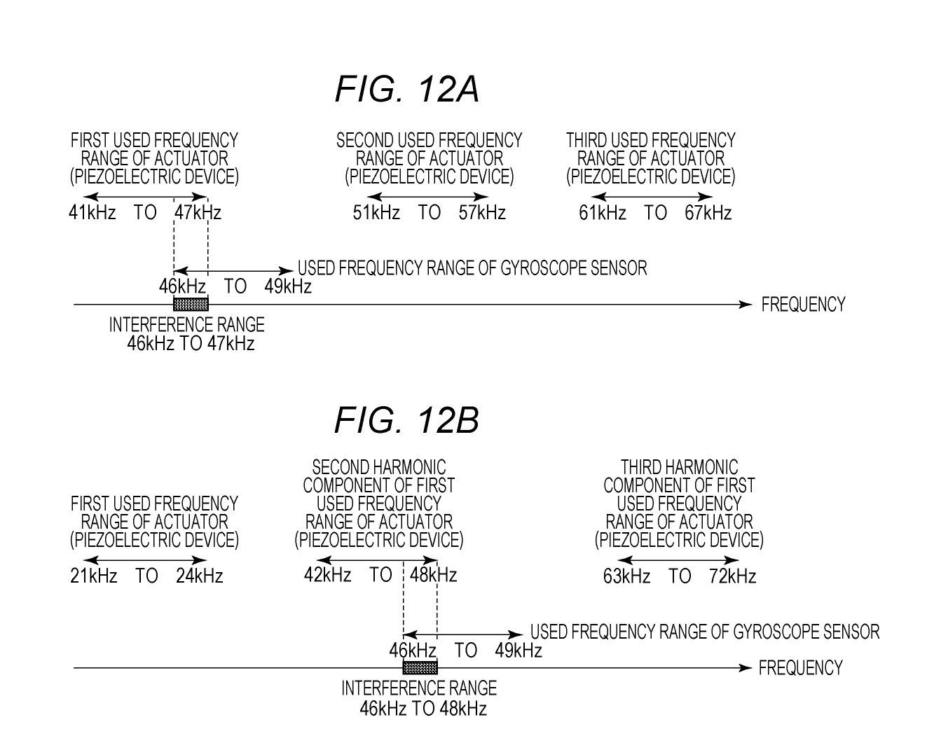

An example where a used frequency range is changed as another form of function limitation at the step S1407 will be described as a fourth embodiment. FIGS. 12A and 12B are charts of a relationship of used frequency ranges of an actuator (a piezoelectric device) and a gyroscope sensor. The used frequencies of the actuator and the gyroscope sensor have an individual difference and the like, and therefore, a certain width is provided as illustrated in FIGS. 12A and 12B. FIG. 12A illustrates that the used frequency ranges of the actuator (the piezoelectric device) and the gyroscope sensor interfere with each other in a range of 46 kHz to 47 kHz in a case where the first used frequency range of the actuator is 41 kHz to 47 kHz. Thus, in the present embodiment, the first used frequency range for the piezoelectric device is changed to a second frequency range or a third frequency range, and in this manner, the frequency ranges used by the actuator (the piezoelectric device) and the gyroscope sensor do not overlap with each other.

An orientation sensing module 800 and an image pickup module 500 as in the smart device of FIGS. 5A and 5B as described above will be described by way of example. In this embodiment, the orientation sensing module 800 has a gyroscope sensor 810, and an image pickup element having a dust reduction function is attached to a camera 510 in the image pickup module 500. In this case, a case where a frequency range used by the gyroscope sensor and a frequency range used by the piezoelectric device for the dust reduction function overlap with each other is assumed.

There is a probability that vibration of the piezoelectric device is synthesized with a “camera shake” correction target signal as described above and leads to erroneous correction driving. For this reason, the frequency range of the piezoelectric device used for the dust reduction function is changed such that the frequency region used by the piezoelectric device and the frequency range used by the gyroscope sensor of the orientation sensing module 800 do not overlap with each other. Such a configuration will be specifically described with reference to FIGS. 12A and 12B. As illustrated in FIG. 12A, multiple frequency ranges are used as the frequency range of the piezoelectric device used for the dust reduction function. The frequency range to be used is, for dust reduction, changed in the order of the first, second, and third frequency ranges. In a case where the frequency range used by the gyroscope sensor and the frequency range used by the piezoelectric device overlap with each other, the first range overlapping with the used range of the gyroscope sensor 810 is excluded, and the frequency range to be used is, for dust reduction, changed in the order of the second and third frequency ranges. Characteristics of the dust reduction function are slightly changed, but it is not necessary to limit a camera shake correction (IS) function for operation based on a gyroscope sensor signal.

According to the above-described fourth embodiment, in a case where the modules such as the actuator and the sensor interfere with each other, the frequency range to be used is changed so that frequency interference can be prevented without function limitation to perform favorable image pickup control.

### Fifth Embodiment

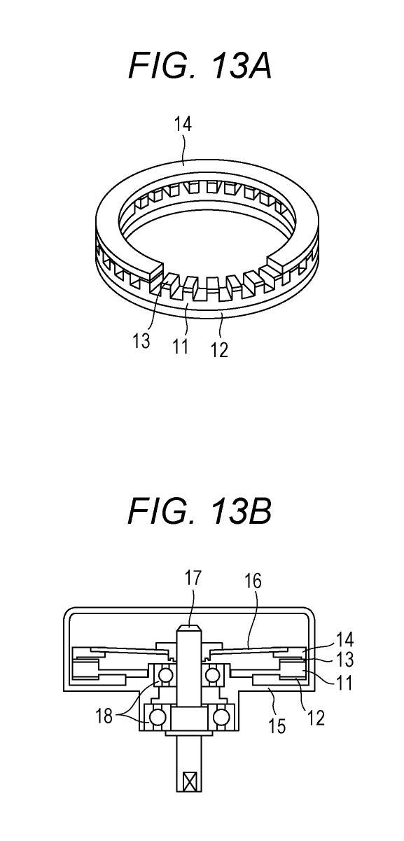

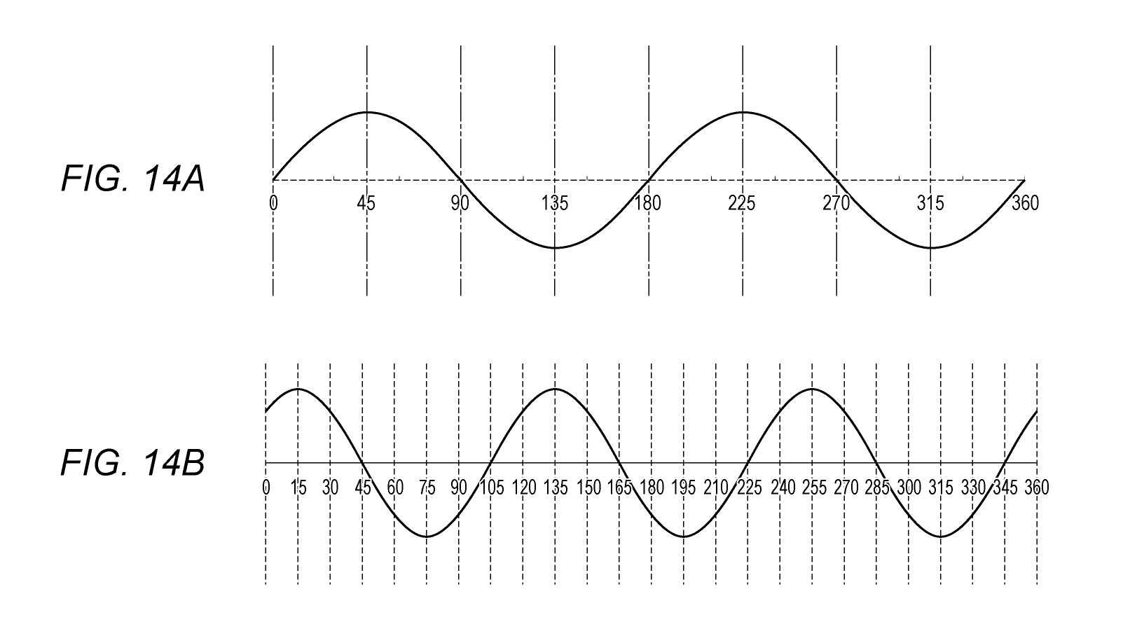

An example of a piezoelectric device according to an embodiment of the present disclosure will be described with reference to FIGS. 13A, 13B, 14A, and 14B. FIGS. 13A and 13B are views of a configuration example of an annular vibration type motor according to the fourth embodiment. FIG. 13A is a perspective view of a vibrator and a movable member (a rotor) partially cut out for the sake of description, and FIG. 13B is a sectional view in a rotation axis direction of a vibration wave driving apparatus. The vibrator illustrated in FIGS. 13A and 13B includes an elastic body 11, a piezoelectric element 12, and friction members 13.

The elastic body 11 is an annular elastic body made of metal, and the piezoelectric element 12 is fixed to a bottom face of the elastic body 11. Grooves for expanding vibration shift are formed on the face of the elastic body 11 opposite to the face fixed to the piezoelectric element 12. The friction member 13 is provided at each tip end of projecting portions formed by these grooves, and a rotor 14 is in pressure contact with the friction members 13. A flange portion thinner than other portions extends toward the center of a circular ring from the inner periphery of the elastic body 11, and is fixed to a base member 15 of the vibration wave driving apparatus. The flange portion exhibiting spring properties is provided at a fixing portion between the elastic body 11 and the base member 15, and therefore, the vibrator can be supported without vibration being interfered.

A disc spring 16 configured to press the rotor 14 in a vibrator direction is fixed to the rotor 14, and the disc spring 16 is fixed to a rotary shaft 17. Thus, the rotor 14 and the rotary shaft 17 rotate integrally.

Bearings 18 configured to support the rotary shaft 17 are provided at the base member. The multiple bearings 18 are arranged in the axis direction to prevent swing of the rotary shaft 17. At the piezoelectric element 12, an electrode pattern for generating two standing waves with the wavelengths thereof being shifted from each other by ¼ is formed. When excitation is performed with the phases of these two standing waves being shifted from each other by 90° in terms of time, progressive vibration is generated at a face of the elastic body 11. By such progressive vibration, the rotor 14 is pushed out, and rotatably moves.

FIGS. 14A and 14B are graphs of an example of the progressive vibration generated at the face of the elastic body according to the embodiment of the present disclosure. FIGS. 14A and 14B illustrate the state of the progressive vibration generated at the face of the elastic body 11 in a case where the used frequency range of the annular vibration type motor is changed.

FIG. 14A illustrates a state in which progressive vibration with two peaks is exhibited on the face. Such vibration is in a second bending mode of the elastic body 11, and has a first used frequency range. Moreover, FIG. 14B illustrates a state in which progressive vibration with three peaks is exhibited on the face. Such vibration is in a third bending mode of the elastic body 11, and has a second used frequency range. The first used frequency range and the second used frequency range are different from each other in frequency, but the rotor 14 can rotatably move by the progressive vibration. Thus, in a case where a frequency range used by another device such as a gyroscope sensor overlaps with, e.g., the first used frequency range, the frequency range used by the piezoelectric device is changed to the second used frequency range so that used frequency interference can be prevented. Moreover, although not shown in the figure, there are multiple fourth, fifth, sixth, . . . bending modes for the annular vibration type motor, and these modes are different from each other in used frequency range. In any bending mode, the rotor 14 can rotatably move by the progressive vibration, and therefore, the frequency range may be changed to other bending modes than the second used frequency range.

Upon driving of an actuator (a piezoelectric device), alternating current used for driving contains a harmonic component, and therefore, vibration of the actuator (the piezoelectric device) also exhibits a harmonic component. In addition, among actuators (piezoelectric devices), vibration generated in an actuator (a piezoelectric device) repeatedly contacting/non-contacting a slide member contains vibration with a n-th harmonic component (n is a natural number) such as the second, third, fourth, fifth, . . . harmonic components. That is, vibration of the actuator (the piezoelectric device) might contain not only a component derived from an electrical signal, but also a harmonic component derived from mechanical contact. Even when the electrical signal shows an identical sine wave, the harmonic component of vibration cannot be completely removed.

For this reason, in the present embodiment, each module is actually operated, and the drive frequency of the piezoelectric device is detected. Then, it is verified whether or not such a drive frequency is superimposed on an output signal of the gyroscope sensor. In FIG. 12B, vibration of the piezoelectric device is superimposed on the output signal (46 kHz to 47 kHz) of the gyroscope sensor in a case where the used frequency range of the actuator (the piezoelectric device) is 23 kHz to 24 kHz. In a case where the used frequency range of the actuator (the piezoelectric device) is 21 kHz to 23 kHz, vibration of the piezoelectric device is not superimposed on the output signal of the gyroscope sensor. Thus, in other cases than the case where the used frequency range of the actuator (the piezoelectric device) is 23 kHz to 24 kHz, operation such as function limitation is not necessarily performed, and a user can use the each module as usual.

In a case where used frequency range information on the module is 21 kHz to 24 kHz, operation such as function limitation for a used frequency range of 21 kHz to 24 kHz is performed in the method for determining frequency interference based on such information. In contrast, in a method in which an actual drive frequency is taken by operation of each module, operation such as function limitation is, as described above, performed only in the case where the used frequency range is 23 kHz to 24 kHz. Thus, the opportunity for the user to use the each module with the limited functions can be reduced.

As described above, according to the fifth embodiment, the presence/absence of interference is determined from the drive frequency when each module such as the actuator or the sensor is actually driven, and therefore, the opportunity to limit the functions can be reduced.

The embodiments of the present disclosure have been described above, but the present disclosure is not limited to the above-described embodiments. As necessary, changes can be made without departing from the gist of the present disclosure. Further, each of the above-described embodiments merely describes one embodiment of the present disclosure, and these embodiments can be combined as necessary. Moreover, the device using the piezoelectric device is not limited to those of the present embodiments, and the present disclosure is also applicable to, e.g., devices for zoom driving, focus driving, mirror driving, shutter driving, diaphragm driving, ND filter driving, and dust reduction.

The preferred embodiments of the present disclosure have been described above, but the present disclosure is not limited to the above-described embodiments in the scope of the technical idea of the present disclosure. The present disclosure is changed and adapted as necessary according to a target circuit form. For example, the camera described as the image pickup apparatus in the above-described embodiments is applicable to a digital still camera and a digital video camera.

According to the present disclosure, in electronic equipment configured to implement functions by means of multiple image pickup modules, the electronic equipment can be operated while malfunction due to a combination of a wide variety of image pickup modules can be prevented.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-134759, filed Jul. 10, 2017, and Japanese Patent Application No. 2017-191749, filed Sep. 29, 2017, which are hereby incorporated by reference herein in their entirety.

What is claimed is:

1. Electronic equipment comprising:
multiple modules including at least one detachable module;
an acquisition unit configured to acquire information regarding a frequency used by each module, the information being stored for the each module; and
a control unit configured to limit or stop operation of at least one module in a case where the frequencies used by the multiple modules interfere with each other based on the frequency information acquired by the acquisition unit.

2. The electronic equipment according to claim 1, wherein
the control unit limits or stops the operation of the at least one module according to whether or not the frequency used by the at least one module interferes with the frequencies used by other modules.

3. The electronic equipment according to claim 1, wherein
the control unit limits part of a function of the at least one module in a case where the frequency used by the at least one module interferes with the frequencies used by other modules.

4. The electronic equipment according to claim 1, further comprising:
a display unit configured to perform displaying to notify limitation or stoppage of the operation when the operation is limited or stopped based on the frequency information.

5. The electronic equipment according to claim 1, wherein
the control unit operates the at least one module with a frequency not interfering with the frequencies used by other modules.

6. The electronic equipment according to claim 4, wherein
the display unit performs displaying to suggest module replacement in a case where the control unit limits the operation.

7. The electronic equipment according to claim 1, wherein
the multiple modules include a storage unit each configured to store the information regarding the frequency used by each self module, and
the acquisition unit acquires, from the storage unit, the information regarding the frequency used by each module.

8. The electronic equipment according to claim 1, wherein
the frequency information is information regarding a drive or detection frequency of each module.

9. The electronic equipment according to claim 1, wherein
the multiple modules include an image pickup unit having an actuator and a gyroscope sensor.

10. A method for controlling electronic equipment holding multiple modules including at least one detachable module, the method comprising:
acquiring information regarding a frequency used by each module, the information being stored for the each module; and
notifying a user in a case where the frequencies used by the multiple modules interfere with each other based on the acquired frequency information.

11. The electronic equipment control method according to claim 10, further comprising:
limiting or stopping module operation in a case where the frequencies used by the multiple modules interfere with each other.

12. The electronic equipment control method according to claim 10, wherein
notification to the user is displaying for suggesting module replacement.

13. The electronic equipment control method according to claim 10, wherein
the multiple modules include an image pickup unit and a gyroscope sensor.

14. An image pickup apparatus comprising:
multiple modules including at least one detachable module;
an acquisition unit configured to acquire information regarding a frequency used by each module, the information being stored for the each module; and
a display unit configured to perform displaying to notify a user in a case where the frequencies used by the multiple modules interfere with each other based on the frequency information acquired by the acquisition unit.

15. The image pickup apparatus according to claim 14, further comprising:
a control unit configured to limit or stop module operation in a case where the frequencies used by the multiple modules interfere with each other.

16. The image pickup apparatus according to claim 14, wherein
the multiple modules include an image pickup unit and a gyroscope sensor.

17. The image pickup apparatus according to claim 14, wherein
a control unit limits part of a module function in a case where the frequencies used by the multiple modules interfere with each other.

18. The image pickup apparatus according to claim 14, wherein
the display unit performs displaying to suggesting image pickup module replacement.
